(19) United States
(12) Patent Application Publication
(10) Pub. No.: US 2003/0191832 A1
(43) Pub. Date: Oct. 9, 2003

(54) Method and apparatus for controlled establishment of a turnkey system providing a centralized data aggregation and summary capability to third party entities

(76) Inventors: Ramakrishna Satyavolu, Santa Clara, CA (US); Subhash Sankuratripati, Mountain View, CA (US); Sampathkumar Ranganathan Pudhukottai, Santa Clara, CA (US); Sin-Mei Tsai, San Francisco, CA (US)

Correspondence Address: CENTRAL COAST PATENT AGENCY, PO BOX 187, AROMAS, CA, 95004, US

(21) Appl. No.: 10/435,430

(22) Filed: May 9, 2003

Related U.S. Application Data
(63) Continuation-in-part of application No. 10/104,296, filed on Mar. 22, 2002.
(63) Continuation-in-part of application No. 09/362,914, filed on Jul. 27, 1999, now Pat. No. 6,517,587.
Application No. 09/362,914 is a continuation-in-part of application No. 09/323,598, filed on Jun. 1, 1999, now Pat. No. 6,199,077.
(60) Provisional application No. 60/278,502, filed on Mar. 23, 2001.

(51) Int. Cl. G06F 15/173; G06F 9/00

(52) U.S. Cl. 709/223; 709/328

(57) ABSTRACT

A distributable software system is disclosed for collecting and aggregating data from a network and for providing compartmentalized and optimized data summaries to third parties. The system includes a data gathering layer for gathering the data; a data normalization layer for normalizing data types from multiple data sources; a data cleansing layer for correcting data inconsistencies; a data enrichment layer for rendering data analyzable; and an application interface layer for providing multiple interfaces to like multiple user applications. An enterprise utilizes the system to provide data aggregation and summary services to clients. In preferred embodiments, intelligence created from the activity is harnessed to provide and improve services and to enhance profitability of the enterprise.

### CROSS-REFERENCE TO RELATED DOCUMENTS

The present invention is continuation in part (CIP) to a patent application Ser. No. 09/362,914 entitled, “Networked Architecture for Enabling Automated Gathering of Information from Web Servers” filed on Jul. 27, 1999, which is a (CIP) to a patent application entitled “Method and Apparatus for Obtaining and Presenting WEB Summaries to Users” filed on Jun. 1, 1999, for which Ser. No. 09/323,598 is assigned, the disclosures of which are incorporated herein by reference. The case also claims priority to a Provisional Patent Application entitled “Turnkey System for Harvesting Personal Information and Providing Same to Subscribers”, bearing U.S. Ser. No. 60/278,502, which application is also incorporated herein in its entirety by reference.

### FIELD OF THE INVENTION

The present invention is in the field of digital network information gathering from network servers and pertains more particularly to methods and apparatus for providing and operating a networked system of machines dedicated to performing automated data gathering, processing, and presentation of such data.

### BACKGROUND OF THE INVENTION

The information network known as the World Wide Web (WWW), which is a subset of the well-known Internet, is arguably the most complete source of publicly accessible information available. Anyone with a suitable Internet appliance such as a personal computer with a standard Internet connection may connect to the Internet and navigate to many thousands of information pages (termed web pages) stored on Internet-connected servers for the purpose of garnering information and initiating transactions with hosts of such servers and pages.

Information travels over the Internet network through many connected computers known as nodes in the art. Internet nodes include any hosted machines dedicated to performing a service such as file serving, data storing, data routing, and so on. Such nodes are generally loosely associated with each other only by universal resource locator (URL) addressing and mapped network paths.

Some data initiated by or requested by users is not protected from being intercepted by some network-connected nodes and therefore may perhaps be observed by third parties due to the nature of publicly-shared bandwidth over the Internet. However, various means for protecting data from being observed by third parties are established and routinely practiced by entities hosting pluralities of nodes connected to the Internet. Such methods include the use of firewall technology, secure servers, and private sub-networks connected to the Internet network.

Many companies doing business on the Internet host semi-private data networks comprising a plurality of computer nodes dedicated to the provision of proprietary information and related data. Certain authorized users such as those working for the company or those having password access and/or active and verifiable accounts with the company may access such data. For example, a large company may host a plurality of file servers, including connected data storage systems wherein users may search for and access data stored for the purpose by the company. Such sub-nets, as they are often termed, use the Internet as a connective wide area network (WAN) and the data travels through shared bandwidth connections. Although a user may be protected from third party interceptions of data sent or requested the user must generally navigate to each URL where data is available. If a search engine is provided to assist a user in searching for specific data made available by the company, it is limited to searching only the nodes hosted by the company or data from third party nodes that is made available through cooperative URL linking or posting.

An information gathering, summarization and presentation system known to the inventor and described in the related patent application entitled “Method and Apparatus for Obtaining and Presenting WEB Summaries to Users” listed under the cross-reference section uses an Internet portal and software suite to allow users to request and obtain data including Web-page summaries containing specific data found by using a unique scripting method supplied by a knowledge worker. In some embodiments such data may also be pushed to a user subscribing to the service.

A service such as that described above requires a considerable amount of processing power in order to service a very large client base in terms of job processing. A desired goal is to automate such an information gathering and presentation service so as to be wholly or largely transparent to individual users.

A data-gathering and reporting system for collecting WEB summaries from the Internet for individual subscribers to a Portal subscription system is known to the inventor and described in disclosure pertinent to the cross-reference patent application Ser. No. 09/362,914 entitled, “Networked Architecture for Enabling Automated Gathering of Information from Web Servers”. The system (see FIG. 2) has a plurality of gatherer servers each connected to the Internet, to an ascending hierarchy of work request distribution servers, and to an ascending hierarchy of collector servers.

A work request generator at the top of the hierarchy of distribution servers generates work requests for collecting WEB summaries, and a filer server at the top of the hierarchy of collector servers writes data to a database. Work flow is by work requests from the work request generator down the hierarchy of distributor servers to the gatherer servers, where work requests are accomplished by gathering WEB summaries from Internet servers according to the work requests, and by data collected from the gatherer servers up the hierarchy of collector servers to the filing server.

In the system just described, there are a lot of separate components comprising the “gathering system”. Each request received from any user is treated as a first request wherein a work or job order is generated to fill the request. It has occurred to the inventors that the capabilities enabled by the novel data gathering and reporting technology can be provisioned to third parties maintaining Internet portals. In this light, services maintained by the provider are accessible through the third parties. However, all of the equipment and software capability resides with the provider and access to functionality is through co-branding using co-brand servers.

It is further desired that in lieu of co-branding many sites to central services, it would be preferable in certain cases to provide turnkey capabilities to third parties willing to pay for them wherein much control of service access and type is maintained by the third party.

Therefore, what is clearly needed is a turnkey package of data gathering, aggregation, and summarization capability that can be economically provided to third parties and maintained in terms of maintenance, update, and security, by the original providing entity.

### SUMMARY OF THE INVENTION

In a preferred embodiment of the present invention a distributable software system for collecting and aggregating data from a network and for providing compartmentalized and optimized data summaries to third parties is provided, comprising a data gathering layer for gathering the data, a data normalization layer for normalizing data types from multiple data sources, a data cleansing layer for correcting data inconsistencies, a data enrichment layer for rendering data analyzable, and an application interface layer for providing multiple interfaces to like multiple user applications. The system is characterized in that an enterprise utilizes the system to provide data aggregation and summary services to clients and wherein intelligence created from the activity is harnessed to improve service and to enhance profitability.

In preferred embodiments the network is a wide-area-network, which may be the Internet network. The system may be distributed whole or in part to an enterprise responsible for operating the system and retained whole or in part by an enterprise providing the distributable portion. The performance of the software system is monitored in whole or in part by the provider of the system for the purpose of maintaining, updating, and enhancing the system. In some cases the intelligence is created by system monitoring from the provider location and wherein summary reports containing the intelligence are created and provided to the enterprise hosting the software system.

IN preferred embodiments the multiple data sources include web sites, online or internal databases, display interfaces, and live data feeds. IN some cases the network is internal to the enterprise operating the software system, and that may be a local area network, and the data gathered includes data from at least one internal database connected to the local area network. In some cases the included data is data obtained from display interfaces connected to the local area network.

In another aspect of the invention a data engine for gathering and processing data from multiple and disparate data sources is provided, comprising a data gathering layer for gathering the data, a data normalization layer for normalizing data types from multiple data sources, a data cleansing layer for correcting data inconsistencies, a data enrichment layer for rendering data analyzable, and an application interface layer for providing multiple interfaces to like multiple user applications. The engine is characterized in that the data engine serves as a central processing hub in an enterprise for generating useful services that are client specific and enterprise specific.

In preferred embodiments the data sources are network sources and the network is the Internet network, or in some cases a local area network. Also in preferred embodiments the data engine is distributed in part to an enterprise responsible for operating the system and retained in part by an enterprise providing the distributable portion. In preferred cases the performance of the data engine is monitored by the provider of the system for the purpose of maintaining, updating, and enhancing the services provided by the engine.

In some cases intelligence is created by system monitoring from the provider location and wherein summary reports containing the intelligence are created and provided to the enterprise hosting the data engine. Data sources may include web sites, online databases, display interfaces, and live data feeds, and also may include an internal database and display systems connected thereto by a local area network internal to a hosting enterprise.

In yet another aspect a data management system having components distributed across a service provider site and a partner site is provided, comprising a system server at the provider site connected by a data link to components at the partner site, for remote monitoring of components at the partner site, a management server at the partner site for overall management of system activities at the partner site, a data gathering engine controlled by the management server for collecting and integrating data from a plurality of data sources accessible by the data gathering engine, a local database for storage of collected and integrated data, and a client interface enabling clients of the partner site to access services at the partner site.

IN preferred embodiments the data sources include one or more of Internet sites, remote legacy sites, and data sources local to the partner site. There may be as well a facility for data cleansing and normalization in the data gathering and integration. In some cases the client interface comprises an Internet-connected WEB server, through which clients may access, through personalized WEB pages, services at the partner site.

In some embodiments the system server provides both monitoring and troubleshooting of operations at the partner site. Further the system server may comprise one or more workstations having a graphical user interface for a knowledge worker to interact with the operations at the partner site. There may further be an update server at the provider site, the update server enabled to provide periodic system updates to components at the partner site. In many cases any one or more of components other than the system server is implemented at the provider site, with the client interface remaining at the partner site.

In yet another aspect of the invention a method for enabling, by a provider, client services requiring data collection for a partner enterprise at a partner site is provided, comprising the steps of (a) establishing at the partner site a management server for overall management of system activities, a data gathering engine controlled by the management server for collecting and integrating data from a plurality of data sources accessible by the data gathering engine, a local database for storage of collected and integrated data, and a client interface enabling clients of the partner site to access services at the partner site; and (b) establishing at the provider site a system server connected by a data link to components at the partner site, for remote monitoring of components at the partner site.

In preferred embodiments of the method the data sources include one or more of Internet sites, remote legacy sites, and data sources local to the partner site. There may further be a facility for data cleansing and normalization in the data gathering and integration.

Also in preferred embodiments the client interface comprises an Internet-connected WEB server, through which clients may access, through personalized WEB pages, services at the partner site. In some cases the system server provides both monitoring and troubleshooting of operations at the partner site, and in some cases the system server comprises one or more workstations having a graphical user interface for a knowledge worker to interact with the operations at the partner site.

There may further be an update server at the provider site, the update server enabled to provide periodic system updates to components at the partner site. Also, any one or more of components other than the system server is implemented at the provider site, with the client interface remaining at the partner site.

In embodiments of the present invention described in enabling detail below, for the first time a data gathering and integration system and method is provided that may be implemented at a third-party partner site, and maintained and monitored from a service-provider's site remote from the partner site.

### BRIEF DESCRIPTION OF THE DRAWINGS FIGURES

FIG. 1 is an architectural overview of a data-gathering network, components, and connectivity according to an embodiment of the present invention.

FIG. 2 is a network diagram illustrating hierarchy and communication direction of part of the automated data-gathering system of FIG. 1.

FIG. 3 is an architectural overview of a data-gathering network, components, and connectivity according to an embodiment of the present invention.

FIG. 4 is an architectural overview of a data-gathering network, components, and connectivity according to an embodiment of the present invention.

FIG. 5 is an architectural overview of a data-gathering network, components, and connectivity according to an embodiment of the present invention.

### DESCRIPTION OF THE PREFERRED EMBODIMENTS

It was described in the background section that in order to provide a viable data gathering and presentation system for servicing a mass clientele, such a system should be dedicated, automated and possess enough processing power to fill a large and continuous user demand. To this end, the inventors provide a scaleable networked architecture that is dedicated to achieving the goals of the present invention in an automated fashion and that is transparent to the user. Such architecture is taught in enabling detail below.

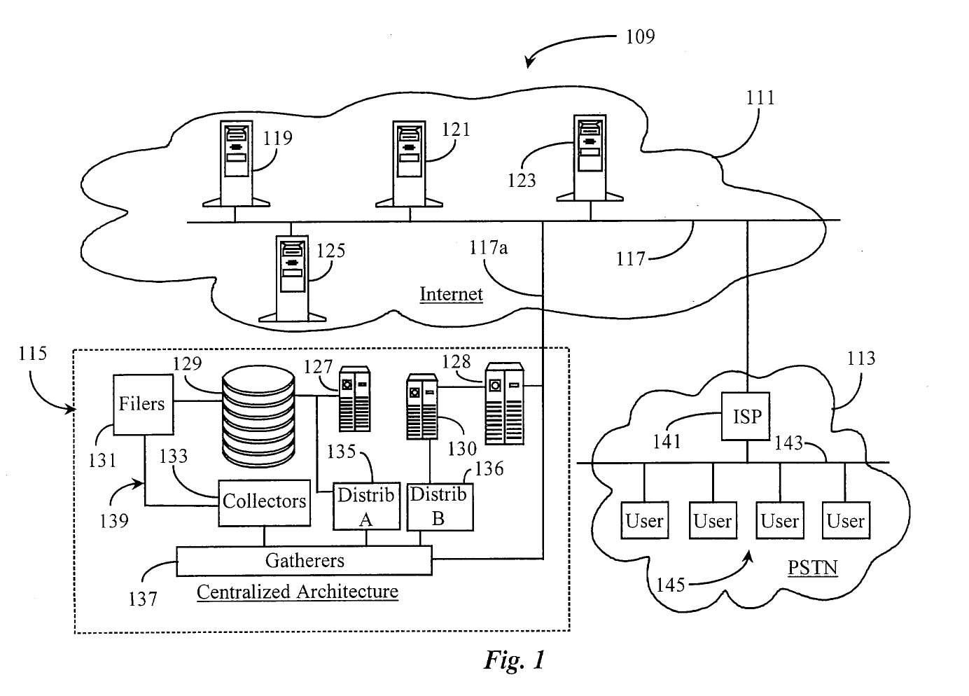

FIG. 1 is an architectural overview of a data-gathering network 109 and components thereof according to an embodiment of the present invention. Network 109 comprises a Data-packet network 11, an automated data gathering system 115, a PSTN network 113, and a plurality of connected users 145.

Data-packet network 111 may be any type of wide area network (WAN) that is known in the art that is capable of data-packet communication. In this embodiment, network 111 is the well-known Internet network, and will hereinafter be referred to as Internet 111. The advantage of using Internet 111 is that it is the largest publicly-accessible data-packet medium available. Another advantage to using Internet 111 is that data communication protocols are well established and standardized. However, any data packet network may be used as long as suitable communication protocols, of which many are known, are in place. Other than the Internet such networks include private corporate Intranets and the like.

Internet 111 comprises a plurality of exemplary WEB servers, 119, 121, 123, and 125, connected to an Internet backbone 117 as is known in the art. Servers 119-125 are adapted as normal file servers dedicated to serving WEB pages in a familiar format such as Hyper Text Markup Language (HTML). These servers are equivalent to servers 23, 25, and 27 of the cross-referenced patent application Ser. No. 09/323,598, from which Web summaries may be gathered.

Internet 111 is connected to a public switched telephone network (PSTN) 113 as is generally known in the art of Internet access. Typical public Internet access involves such as an Internet service provider (ISP) represented herein by element number 141, which is accessed over a conventional telephone network connection system represented by element number 143. A plurality of users 145, shown connected to ISP 141 represent the most common method for public access to Internet 111 . There are several other methods known in the art for accomplishing access to Internet 111 such as continual corporate connections, satellite connections, etc, and the system shown is merely exemplary.

Network 109 uses the Internet 111 and PSTN 113 in order to establish convenient access capability for users 145. Users 145, in this example may be assumed to have typical internet access capability as is known in the art, typically including a PC, a telephone line, and a modem for dialing up the ISP. Users 145 may also be operating satellite connections, WEB TV cable connections, or any other known Internet connection that may be completed using one of a variety of Internet-capable appliances, including appliances having wireless connection, such as combinations of cell phones with personal organizer and computer capability. Although there are only four users 145 represented in this example, it will be appreciated that there will be many more such that a mass clientele is established creating a heavy demand on system 109.

It is disclosed in the cross-referenced patent application that users may obtain WEB summaries relating to virtually any WEB page available on the Internet. Such Web pages include those URLs in individual URL lists maintained for the users (subscribers), any other URL that may be identified to the system by a user, and individual Web accounts. This process is automated except for directional input by the user and scripting supplied by knowledge workers, and is a function of server 128 shown in FIG. 1 within architecture 115. Server 128 is equivalent to server 31, of FIG. 1 of the cross-referenced patent application, and provides portal functions including the obtaining and presenting of Web summaries to users, as well as automatic authentication of user's accounts as gathering is done, through the features of the Portal server, which is the subject of cross-referenced patent application 09/208,740. In order to insure that an information gathering and summarization service such as the one described in the related application will be able to service an exceptionally large client base, a unique architecture comprising dedicated machines and networked connections must be provided. Architecture 115 represents an automated data gathering and presentation system adapted to provide optimum performance in the processing of mass information requests coming in continually from users such as users 145. In this embodiment, architecture 115 is centralized (housed in one location), however; a centralized architecture is not required in order to practice the present invention. In an alternative embodiment architecture 115 may be distributed geographically throughout Internet 111.

Architecture 115 comprises a dedicated network of cooperating machines adapted to practice the functions of the present invention. Architecture 115 is hierarchical in construction in some parts meaning that pluralities of slave components at intermediate levels are ultimately directed by one master component. Architecture 115 comprises at least one scheduled update server 127 adapted to enter into and identify data-gathering job assignments that are stored in a database. A database holding such work may be stored in such as a mass repository 129 that is illustrated as connected to server 127. Mass repository 129 is in a preferred embodiment an off-line storage facility and may be accessed and updated by server 127. Mass repository 129 is large enough in terms of data-storage space to contain all user-profile and user initiated requests for information. In alternative embodiments, more than one mass repository such as repository 129 may be used. Mass repository 129 may be of any type known in the art such as an optical storage facility, or other known mass storage system, or a combination of different types.

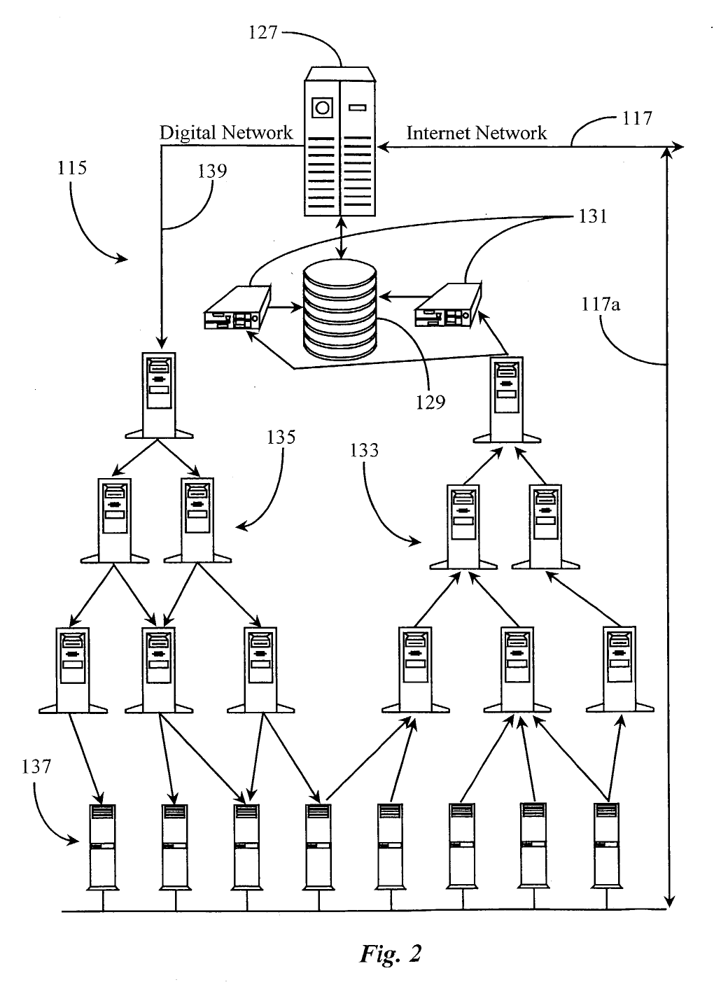

Database server 127 distributes scheduled work assignments in hierarchical fashion to a plurality of connected distributor servers 135. Distributors 135 are connected to each other and to server 127 by dedicated network 139, as is described below with reference to FIG. 2. Each distributor server 135 contains a work queue (not shown) adapted to hold job assignments until they are requested from another distributor further down the hierarchical line, thus the distribution of tasks for distributors coupled to server 127 is by pull technology, providing efficient loading. This effectively provides a distributed queue that automatically load balances on the number of servers available. In this way work is pulled down from distributor to distributor, as respective work-queues become able to handle more work. The ultimate goal of each distributor is to pass all of its work assignments down until they are ultimately received by a plurality of connected gatherer machines 137.

A second scheduling server 130 is connected to server 128 and is dedicated to handling not scheduled, but instant-update requests from users 145. Users may communicate such information-gathering requests to server 128 via the Internet, and server 130 acts through a second set of instant-update distributors 136 to gatherers 137. Distributors 136 do not operate by pull technology, but rather on demand to immediately execute instant update requests. These distributors have their queues refilled by user requests rather than by database queries.

Gatherers 137 are adapted to obtain work assignments from distributors 135, and perform the assigned functions with respect to each job. Each gatherer 137 has a work queue (not shown) adapted to hold job assignments passed down from distributors 135. As individual work queues become depleted, gatherers 137 request additional work from associated distributors up the line. Dedicated network 139 connects gatherers 137 to distributors 135.

It is the objective goal of all gatherers to navigate Internet 111, and pull data from WEB servers such as from servers 119-125 and process the data according to their job assignments. To achieve this purpose, each gatherer is afforded a full-time Internet connection represented herein by a data connection line 117a illustrated as teeing off backbone 117. Database server 127 also has a full-time Internet connection illustrated herein as a branch of data connection 117a. In addition to having an Internet connection for navigating Internet 111, each gatherer is provided with enough additional processing power and suitable software to perform its organization and rendering of data into a suitable format as to be compatible to users such as users 145.

Internet connectivity with respect to server 127 allows users 145 to upload data requests using suitable software on their Internet appliances. Such software is not shown here. However, a suitable example is taught in the cross-referenced patent application. The Internet connection afforded to server 127 is a user connection allowing bi-directional communication. In contrast, the Internet connections afforded to gatherers 137 are dedicated to allowing them to navigate Internet 111 and retrieve particular data according to job assignment. There is no user communication with gatherers 137. The navigation process generic to gatherers 137 is wholly automated and transparent to users.

As gatherers 137 complete their job assignments, the associated data is passed on to a plurality of machines represented herein by element number 133 and termed collectors by the inventors. Collectors 133 are computer nodes adapted to efficiently collect data and to pass the data back to the database held in mass repository 129. Collectors 133 are connected to gatherers 137 via digital network 139. Each collector accepts completed data packages passed on to them by gatherers 137. The movement of data through the hierarchy of the collectors is by push technology.

Eventually, collectors pass completed jobs on to powerful filer processors. Filers 131 are dedicated and adapted to writing finished data directly into the database stored in repository 129. In this example, following the disclosure of the cross-referenced patent application, finished data represents WEB summaries requested of system 109 by users 145 as taught in the cross-referenced patent application. Similarly, the software used in conjunction with communication system 109 could be identical or similar to the software taught therein.

It is noted here, and supported by repeated references to digital network 139 that the entire architecture 115 is held off-line (not connected to the Internet) save for the described connection to server 127 and connections provided to gatherers 137. In this regard, digital network 139 is a separate and dedicated network adapted for swift transmission of data between connected machines. In this way, no competition exists for precious bandwidth resources. In a centralized scenario such as is exemplified in this embodiment, network 139 may be implemented economically and efficiently.

Network 139 may or may not be adapted to communicate via Internet protocol as long as database server 127 has a means for interpretation and rendering of alternate data formats into HTML, XML, or another suitable format for serving the data information to users 145 (typically in the form of a WEB page). The language in any case is a markup language, and is therefore extensible over time. In order to save storage space architecture 115 may use a metadata system of communication between connected nodes and storage facility 129.

It will be apparent to one with skill in the art that the exemplary architecture described above may be used with virtually any type of information gathering service that uses a client and parent software application without departing from the spirit and scope of the present invention. For example, a large corporation or technical campus may practice the present invention privately using the architecture described above on a private or corporate WAN instead of the Internet. One may also run on a Virtual Private Network (VPN) on top of the Internet backbone. The inventor intends that architecture 115 may be used with the WEB-summary service described in the related patent application referenced above, and therefore, is designed for that purpose in this embodiment. Slight modifications may be made to machines and connections in order to adapt architecture 115 to other variations of WEB-based or network-based information gathering and presentation services.

The unique hierarchical connection scheme provided to architecture 115 provides optimum scalability to accommodate increased or decreased user demand. Furthermore, a fact that only one machine is required to have bi-directional communication capability with storage facility 129 insures economy and practicability with regard to socket connection requirements. More detail regarding the hierarchy of architecture 115 is provided below.

FIG. 2 is a network diagram illustrating hierarchy and communication direction of part of the architecture 115 of FIG. 1. In this example, architecture 115 is held on a separate digital network 139 as described above with reference to FIG. 1. However, in an alternative embodiment, architecture 115 may be distributed over a WAN using the WAN, which could be the Internet, as a communication medium rather than a separate digital network as described in FIG. 1.

In the above-described embodiment, all nodes would be slaved to their master nodes by addressing techniques on the WAN rather than hierarchical connection by a separate network. In still another embodiment, a separate digital network may still be provided to run in parallel with the WAN. The purpose of using a separate dedicated network to connect all nodes is to speed up transmission of data in the loop.

Referring back to FIG. 2, architecture 115 for scheduled updates utilizes database server 127 at the very top of the hierarchy. Server 127 manages data stored in repository 129 and communicates to users via Internet path 117. Server 127 has access to user-profile address lists, and users 145 (FIG. 1) also upload special requests to server 128 (FIG. 1) which are handled via server 130 and distributor hierarchy 136 (not shown in FIG. 2). As data gathering requirements come due according to user profiles and requests from users 145 are logged and stored, work assignments representing unfulfilled request are created and distributed over network 139 for scheduled requests to distributors 135 using a trickle-down pull technique as illustrated by the directional “communication” arrows connecting each distributor. For example, there are six distributors 135 represented in this hierarchical tree. The top distributor pulls assignments from server 127 and passes them on to two distributors “down the tree”, which in turn pass them on to three distributors further down the tree. The passing on, however, is controlled by queues at each distributor having adjustable thresholds. As a queue at a distributor falls below a specified threshold, the distributor requests more work assignments from the higher-level distributors to which it is slaved.

It will be appreciated by one with skill in the art that there may be more than one distributor at the top of the tree passing assignments to still more distributors down the tree than are illustrated in this embodiment. The inventors intend to illustrate only the nature of cascading assignments to more and more distributors situated down the tree, by the queue-controlled pull technique.

Ultimately, a lower level of distributors 135 will distribute assignments to gatherers 137. It is the gatherer's job to accomplish the job assignments by navigating the Internet (111) by virtue of Internet connection 117a and the URL lists associated with the job assignments, and to retrieve information requested in each given job assignment held in their queues. To achieve this end, each gatherer 137 is equipped with suitable navigational software and parsing capability as described in the cross-referenced patent application. The inventors also refer to gatherers 137 as agents. In this embodiment, gatherers 137 also summarize and organize retrieved data into WEB-summaries according to user direction as passed on with the work assignments. The exact nature of job performance attributed to gatherers 137 will, of course, be dictated by the software and processing capability afforded them. As previously described, other information sourced from the Internet or any other data network may be obtained and processed according to predetermined rules.

Gatherers 137 have connection ports provided and adapted for pulling information from distributors 135. Gatherers 137 are similarly provided with connection ports that are adapted for passing information to collectors 133 as illustrated by the directional “communication” arrows. These ports are associated with network 139 and not with Internet 111. A third port is provided for each gatherer to access the Internet or other designated WAN.

The gatherers are queue-managed, as are the distributors, so the gatherers pull work assignments from the distributors according to queue thresholds, just as lower-level distributors work with higher-level distributors. The collectors 133 push collected data from completed assignments from the gatherers up the collector network to the filer or filers.

It can be seen in this example that a hierarchical loop is created that ultimately ends back at repository 129. For example, A top-level collector or collectors 133 pass completed job assignments to filers 131, which are connected to and write data directly to repository 129 updating the database. Filers 131 may be provided as one or more powerful processors, or a lager number of less powerful processors. Moreover, a secondary or failsafe contingent of filers 131 may be provided and adapted to take over in the event that first-line filers fail for any reason.

Processing power may be regulated with respect to all connected nodes such that data is continually being streamed down and back up the loop created by network 139 without being held up. In one embodiment, additional failsafe connections may be provided between connected nodes at a same level in the tree such that if one node appears ready to fail or needs to be withdrawn from the hierarchy for any reason, it's queue may be emptied to adjacent nodes.

In another embodiment of the present invention, a means for detecting and mirroring duplicate requests is provided. This is provided in one embodiment in the form of a second database representing completed assignments and user attributes and a software module that checks for duplicate requests coming into server 127 against a first database containing all unfulfilled requests and those requests already in process. If a duplicate or more than one duplicate request is discovered such as, perhaps, return today's New York Times headlines, then only the leading request (one being processed) of the same nature is allowed to proceed. Once the request is written into repository 129 by one of filers 131, it is mirrored or made available to all of the users that initiated the same request. In this way, much unnecessary work may be eliminated from the process to affect streamlining.

In still another embodiment, a priority system may be used in the queuing and distribution of work assignments. In this embodiment, on-demand requests may take priority over requests that will be accessed at a later time by users. For example, priority requests may be tagged according to priority upon receipt by any means known in the art and caused to trickle through each queue according to that priority such that they may gain on and surpass other requests of lesser priority moving through the system. Any priority system may be adopted and used by system 109 according to enterprise rules.

In still a further embodiment of the present invention, gatherers 137 may, if overloaded to a point wherein they are causing an unacceptable amount of latency, use their Internet connection to send completed job assignments over Internet paths 117a and 117 to a duplicate or mirrored site that is distributed elsewhere on Internet 111. Such a mirrored site may have a separate digital network and nodes connected thereto just as architecture 115. It may be a case wherein the second site is not operating to capacity and could handle the extra load. Such a second site may be connected to a first site via Internet connection as described, or may also have a dedicated data link connecting to the first site and adapted to become active only when required for load balancing.

Server 127 is, in a preferred embodiment, adapted to notify users 145 when their requests are available in the case of user-initiated requests, and to schedule delivery of updates according to stored user profiles. This is accomplished via Internet path 117. In some cases, requests may be delivered if so ordered. In other cases they may be pulled from server 127 or another connected server adapted for the purpose. As to network 139, a push system is used. Work assignments are pushed from each node to the next. This concept acts to discourage any overload. A separate data storage facility may be provided wherein users may access completed requests. Un-accessed requests may be purged after a period of time. Similarly, requests that have been accessed or delivered are also purged from the system.

If the entire system is operating at maximum capacity, then server 127 may be programmed to slow or stop the receiving of requests until such time that the system is deemed capable of handling more work at the desired pace. Such a condition would alert system administrators of a need to scale-up according to more demand. Similarly, if there is a lull in workflow, then parts of the system may be shutdown without affecting system performance. Ultimately, a system could be scaled down if needed.

Primary access to system 109 may be provided at the ISP level such as with the Internet Portal server described in the cross-referenced patent application. Subscribers may first have to verify identity and perhaps use a password before being allowed to access server 127. In some cases, interface servers may be provided and distributed over different regions wherein requests from those servers are delivered to a server such as server 127.

It will be apparent to one with skill in the art that a networked system architecture such as architecture 115 may be wholly automated and adapted to perform a wide variety of information gathering and presentation services. For example, architecture 115 may be used for obtaining and presenting WEB-summaries as is the case in this example, or it may be adapted to such use as returning review summaries to administrative workers regarding completed cases or other review work. There are many possible and varied implementations.

Turnkey System for Data Gathering and Processing

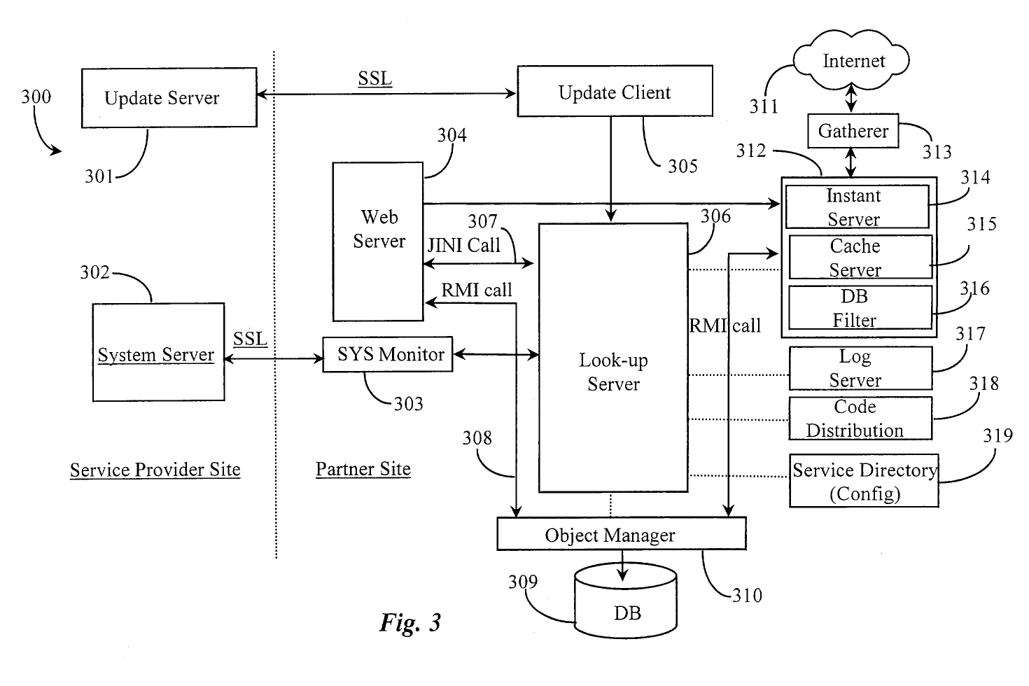

FIG. 3 is an architectural overview of a turnkey system 300, which is a hardware/software data-gathering network comprised of a plurality of networked components functioning according to an embodiment of the present invention. Much of the architecture of system 300 is located, in this example, at a client site termed a “Partner Site” which is so labeled to the right of a division line (vertical dashed line) logically separating a service provider site from the partner site. This is exemplary only, and the nature of the system is such that many of the components shown as at the partner site may be implemented at the provider site instead. There is no strict requirement for the location of components.

Within the domain of the service provider in this example, an update server 301 is illustrated. Update server 301 is adapted to provide data, service, and other updates. Also illustrated within the domain of the service provider is a system server 302. System server 302 is adapted to provide remote monitoring capability to personnel of the service provider.

Network communication between the service provider site and the partner site is accomplished in a preferred embodiment over a secure socket layer (SSL) enabled data link, or a system of links. In other embodiments, other secure protocols may be used. In this example, an SSL-enabled connection is illustrated from both servers 301 and 302 to components in the partner domain. Within the partner site, there are a number of components that make up the turnkey aggregation system comprising data gathering, aggregation, analytical and summarization elements. These elements are described in more detail below.

It is noted herein that the exact nature and configuration of network components within the partner domain will depend in part upon the nature of an agreement forged between the partner and the service provider. For example, the hardware components illustrated may already be owned and maintained in facilities at the Partner Site necessitating just software and a few network architecture adjustments to enable the system. In another embodiment most of the elements are leased or sold to the partner entity along with the proprietary software required to accomplish the turnkey system.

A core component of the partner domain is illustrated here as a look-up server 306. Look-up server 306, among other tasks, is adapted as a service and component directory wherein networked components and services that are part of the system are recognized by address and by current state of activity. Server 306 represents a central management server for organizing activities. An update client component 305 is illustrated within the partner domain and has direct access to look-up server 306. Client 305 is a software component that can operate on look-up server 306, or it can be provided to run on a separate component as is illustrated herein. Update client 305 has direct communication over SSL with update server 301 within the domain of the service provider. By this mechanism, the service provider may provide updates of service content, software version, new components, and other types of updates directly to look-up server 306, which can apply and/or deliver the updates to components as needed.

A web server 304 is illustrated within the domain of the partner site and is adapted as a main access portal or customer-access server for services available from the partner. Web server 304 has a wide connection (not shown) to an Internet or other WAN for the purpose of enabling customer access. Web server 304 typically serves HTML pages representative of the partner entity including provision for secure customer access. Other familiar Web protocols that may be enabled within server 304 include SOAP, XML, WML, and others. Clients of the partner entity access the entity service through Web server 304.

A system monitor 303 is illustrated within the partner domain and is adapted as a software client to system server 302. System monitor 303 may reside, in one embodiment, inside look-up server 306, or it may be provided to run on a separate component as is illustrated herein. System monitor 303 has direct communication capability with server 306 and with server 302 as illustrated by bi-directional arrows connecting the components. Monitor 303 provides real time information about system status by virtue of its association with look-up server 306 and reports status to server 302 wherein the information provided can be processed by machine and or human entities.

System server 302 may be a plurality of computerized stations, each station supporting a graphic user interface (GUI) and individually manned by a system monitoring team. Those entities operating at the level of server 302 may pass configuration and other types of knowledge or optimization to look-up server 306, and perform troubleshooting and repair functions. These may amount to updates in real time, similar to operation described with reference to update server 301. In one embodiment, servers 301 and 302 are connected to each other or reside as one single entity running on one component machine.

An object manager 310 is illustrated within the partner domain and is adapted as an object-oriented management of objects representing components and functions of the system of the invention. In this embodiment, object manager 310 provides the capability of managing different interfaces, architectures, protocols, languages, and component versioning to ensure compatibility of information stored in and retrieved from a database illustrated herein as database 309. Database 309 is typically a relational database with object support. However other types of known systems may be used.

Web server 304 can access database 309 through object manager 310, which provides an added layer of security against potential hackers. Remote Method Invocation (RMI) protocol is practiced from Web server 304 to Object Manager 310. A general server component 312 is illustrated within the partner domain and comprises an instant server 314, a cache server 315, and a database filter 316. Server 312 communicates with database 309 through object manager 310 as was described with reference to server 304 via RMI protocol. The main function of server 312 comprising components 314-316 is to receive and process jog orders representing requests for information. Requests for information may come from internal components or from clients through Web-server 304.

A gatherer component 313 is illustrated within the partner domain and logically represents automated navigation and data gathering capabilities. Gatherer 313 accepts commands from server 312 according to navigation template and machine readable commands. A gatherer can be thought of as an instance or agent (software) that is spawned for one or a series of requests. Therefore, gathering capability can reside in a number of machines or in one powerful machine.

A log server 317 is illustrated within the partner domain and is adapted to maintain and serve logged data reports previously logged for a variety of activities. For example, log server 317 serves high-level data reports about client activity realized through server 304. More traditional log reports, like service installation logs, error logs, and the like are also served by server 317.

A code distribution server is provided within the partner domain and is adapted to automatically look-up components through server 306 and server code to those components as required and when they are ready (logged into the system) to receive code. Examples of code may be a new version of a software component required for data gathering. In this case, server 318 having received the code for distribution would distribute the code to the gatherer component 313 when it logs into the system, in this case, through server 312.

A service directory (configuration) server 319 is illustrated within the partner domain and-adapted to enable remote configuration of the service and component hierarchy within server 306. In a preferred embodiment, servers 317-319 actually reside within server 306 and are illustrated separately herein only to show separate function. For example, update client 305 would provide new code to code-distribution server 318 for distribution to other components as needed. Moreover, updates to service configuration may proceed through update client 305 to service directory configuration server 319. Server 319 is responsible for applying the service configuration updates.

Turnkey System 300 has access to a wide area network (WAN), in a preferred embodiment the Internet network, as is illustrated herein with a cloud icon labeled Internet and given the element number 311. Internet 311 is accessed through the gathering component 313. Internet 311 may include other connected networks like corporate Intranets, academic and government LANs, and other intranet networks available to the partner entity through essentially any sort of connection, and as may be configured through the partner entity for specific clients of the partner entity. Legacy systems may be included as well, either directly or through Internet gateways. There is essentially no limit to the variety and range of data sources that may be accessed and mined.

Turnkey system 300 provides a complete hardware/software solution for data gathering, aggregation, and summary services for clients. In practice of the invention, clients access system 300 through Web server 304. In this regard, Web server 304 may be a portal server. Clients may request data aggregation and summary services and configure those services to provide them with pertinent information about many aspects of personal business, for example. Within system 300, client data may be keyed to any of a range of identifications, depending on the nature and configuration of the client-side system. For example, a common and much-used ID for data access regarding a client may be account number. In other cases ID such as name, alias, address, telephone number, e-mail address, and so on may be used.

In addition to client services, turnkey system 300 provides a unique capability of developing and refining data associated with client activity including purchase activities, navigation activities, product preferences, demographics, and other useful marketing information that can be develop refined and made available to third party entities marketing products to and/or services.

The heart of the aggregation system is automated data gathering, aggregating, and storing of data for use by clients or for use by one or more enterprises. Server 312 in conjunction with gatherer 313 respond to client requests initiated from Web server 304. In a case wherein data answering the request is already stored in database 309, then cache server 315 is employed to retrieve data on behalf of the request. However, if data answering a request is not available from database 309 then gatherer 313 must navigate to a data source, in this case one located in Internet 311, and retrieve data that answers the request.

A client request may also involve periodic refreshing of request data such that instant server 314 automatically invokes gatherer 313 periodically to navigate to data source and retrieve any new data on behalf of a request. A company providing services to a great number of clients of can benefit enormously from being able to service the clients and the same time learn volumes of information about the clients.

It will be apparent to one with skill in the art of the architecture and components illustrated this example maybe change or may be modified from the described form without departing for the spirit and scope of the present invention. For example in one embodiment, the responsibilities of object manager 310 are provided as an in-process object layer instead of a separate object manager component 310 is illustrated in this example. An object layer of software can be absorbed in database 309 with clients in server 312 and server 304. In still another embodiment, a mega-server approach is utilized wherein server 312 and object manager 310 are combined into one server maintain in between database 309 and Web server 304 as well as in between database 309 and gatherer 313. Each variance in the architectural implementation has advantages and disadvantages. There are many possibilities for optimum configuration. Turnkey system 300 is supported by a software application that is distributed over the architecture described in this example. The software application of the present invention will be described in more detail below.

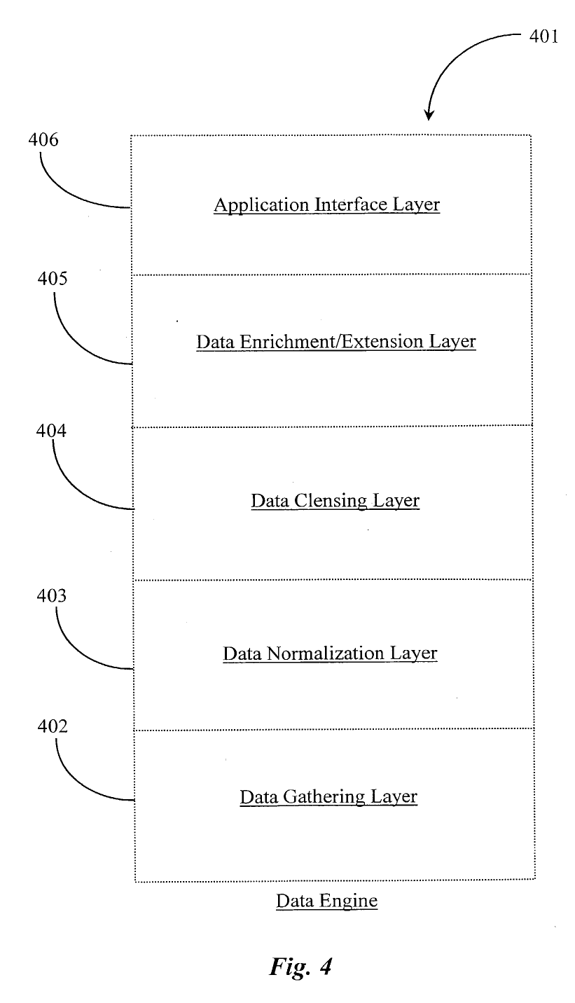

FIG. 4 is a block diagram illustrating several layers of a software data aggregation and presentation application according to an embodiment of the present invention. At the heart of turnkey system 300 is a supporting software application termed a data engine by the inventor and referred to herein after as data engine 401. Data engine 401 comprises several software layers of adapted to perform various functions. A data-gathering layer 402 is provided as part of data engine 401 and adapted for gathering data from multiple data sources. Data that is gathered is also aggregated within data-gathering layer 402.

Data gathering capability supported by layer 402 includes structured data sources such as HTML, WML, and other standard web page formats as well as XML. QIF, QFX, OFX, IFX data feeds are also supported. These types of data sources are readily accessible through navigation to and data retrieval from sources available on the Internet or other WAN or LAN networks as described with reference to FIG. 3 above. Such gathering capability can be invoked through direct request, periodic refresh, and through real-time monitoring. Additionally, data-gathering layer 402 supports gathering and aggregating data from sources that are internal to a hosting enterprise. These data sources include but are not limited to legacy systems databases, flat file pools, operating data queues, and in-house data logs. Examples include OBDC and JBDC data formats. SOAP and TIBCO Real-time Bus data formats are also supported. Layer 402 also supports gathering data from third party data sources such as data processors, data custodians, and the like what stored data from multiple accounts for multiple users.

A data normalization layer 403 is provided within data engine 401 and adapted to normalize data types from multiple data sources having different formats and platforms. Data gathered through data gathering layer 402 is normalized into a common machine language model such as XML or the like. Data normalization is accomplished using an extensible data schema and translation module, which comprises a core data set that is common to the target industry. Data is normalized at semantic and syntactic levels. An example of syntactic normalization would be the normalization of a date component having variable of mm/dd/yy, which is a format generic to U.S. banks and dd/mm/yy, which is the generic format of UK banks. The core data set has an extension that can be customer specific. In this way the customer may extend or modify (personalize) the schema by editing a configuration file and XML or other common descriptor language and then generating all of the code in database logic required to accomplish the extension. A preferred embodiment, all data required from internal and external sources is normalized into this common scheme. An example of semantic normalization would be normalizing a “total account balance” between two separate reporting sources such as perhaps E-Trade™ where a cash balance figure is normally included verses Merrill Lynch™ where it is not included.

A data cleansing layer 404 is provided as part of data engine 401 and is adapted to cleanse or correct data inconsistencies before other operations are performed. Data collected from multiple sources and aggregated as a data set is usually not ready for analytic processes to be performed on it. In this case data may be auto-corrected when certain inconsistencies are discovered or in some instances users may be simply alerted to inconsistencies and be enabled to manually correct them. Data cleansing may include generation of unique transaction identifiers, normalization of stock ticker information, data reconciliation against a system of record, and identification and alert to discovery of missing transactions.

A data enrichment/extension layer is provided within data engine 401 and is adapted to perform data enrichment for the purpose of rendering the data analyzable. Data is not always rich enough on its own merit to be useful in analyzing. Therefore third party resources are leveraged to enrich the data so that it is valuable for analysis. One enrichment example would be a currency conversion module for customizing a rate source. Other examples include transaction classification, stock asset “typing” and industry segmentation, providing historical stock pricing information, and tax lot accounting.

An application layer 406 is provided as part of data engine 401 and is adapted to provide application interface capability to a variety of useful applications. Once data is processed through all of the mentioned software layers, it can pass to created or existing software applications for user purposes. Custom applications (created) can be built directly on top of the processed data such as financial analysis applications, identity verification applications, and the like. Application adaptors can be provided to carry data to other existing applications or through a hierarchy of separate applications. A common language format like SOAP or other data distribution mechanisms can be used to pass data through various adaptors into various applications. Example applications include but are not limited to those that perform portfolio analysis, product marketing, campaign management, customer resource management (CRM), billing, Web presence reporting, communication center applications, online banking applications and so on.

Data engine 401 is adapted to be deployed in full or in part as a turnkey service for clients with typically large and complex service mappings. For example, layers catering to customer service and analytical capabilities may be held in the provider domain while the data gathering and aggregation capabilities are deployed at the partner site. There are many customizable situations. The data engine as a whole application enables a central data hub for managing all customer and enterprise data from both within and from outside the enterprise. A universal view of the data is enabled for use in applications ranging from financial services, healthcare services, government services, or other applications common to enterprises having multiple data sources typically drawn upon.

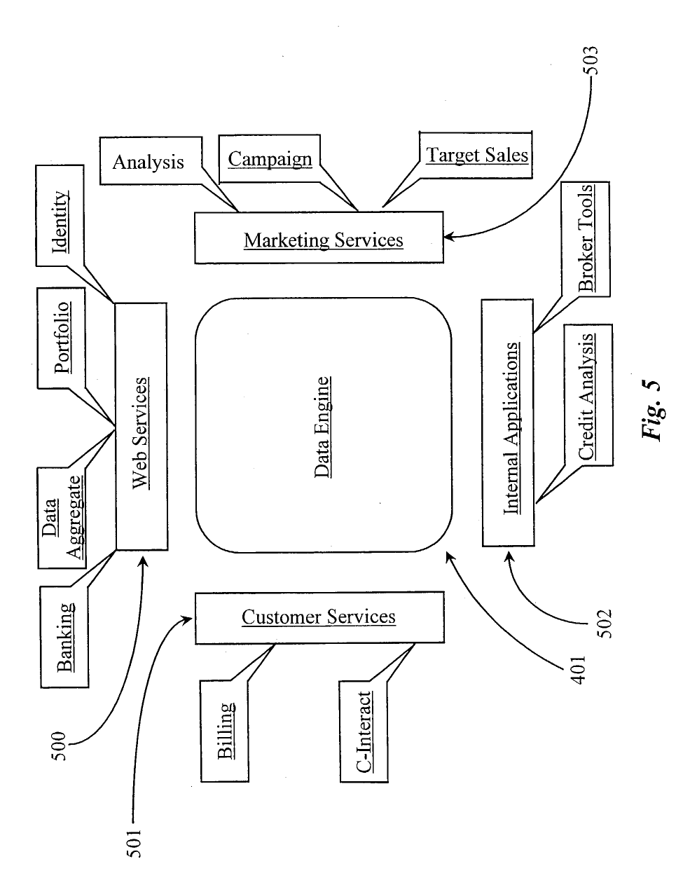

FIG. 5 is a block diagram illustrating a range of capability supported by the data engine of FIG. 4. Engine 401 supports 4 main areas of enterprise listed herein as Web services 500, Marketing services 503, Internal Application services 502, and Customer services 501. In a preferred embodiment, Web services 500 include, but are not limited to, online banking services, data aggregation services, financial portfolio management services, and identity verification services as illustrated by associated information boxes labeled Banking, Aggregation, Portfolio and Identity.

Marketing services 503 include but are not limited to target sales management, campaign management, and market analysis as illustrated herein by the associated information blocks labeled Target Sales, Campaign, and Analysis. Internal applications 502 include but are not limited to credit analysis and broker tools illustrated herein by associate information blocks labeled Credit Analysis and Broker Tools. Internal applications 502 may also include customer activity analysis and other analysis tasks designed to optimize internal performance such as error analysis. Customer services 501 include, but is not limited to customer billing and customer interaction policies as illustrated herein by the associated information blocks labeled Billing and C-Interact.

Referring now back to FIG. 3, the service provider can monitor the activity of turnkey system 300 as it is used at the partner site domain. It is accomplished using system monitor 303 that reports to system server 302 in the domain of the service provider over secure socket layer connection. System monitoring might be performed under a variety of different auspices enhanced according to pre-determined capability levels forged under contractual arrangement. For example, system diagnostic services may be practiced at the service provider domain wherein a team of specialists monitors system performance including efficiency, error rate, and profitability. Data may also be collected relative to the quality and responsiveness of the system to users needs. In addition, the monitoring capability allows specialists to be aware of problem areas for maintenance of the system or for suggesting enhancement actions and for anticipated problems or methods for improving system speed, performance, and quality of data reporting. Updates to system 300 can include patches and fixes designed to enhance consumer and enterprise experience.

In another embodiment, system monitoring may include monitoring of consumer activity both in terms of online activity and in terms of aggregated information wherein optimization summary reports may be created in a general sense that provide direction to the enterprise as to how to enhance services for their clients and gain more profitability for their enterprise.

What is claimed is:

1. A distributable software system for collecting and aggregating data from a network and for providing compartmentalized and optimized data summaries to third parties comprising:
a data gathering layer for gathering the data;
a data normalization layer for normalizing data types from multiple data sources;
a data cleansing layer for correcting data inconsistencies;
a data enrichment layer for rendering data analyzable; and
an application interface layer for providing multiple interfaces to like multiple user applications;
characterized in that an enterprise utilizes the system to provide data aggregation and summary services to clients and wherein intelligence created from the activity is harnessed to improve service and to enhance profitability.

2. The software system of claim 1 wherein the network is a wide-area-network.

3. The software system of claim 2 wherein the wide-area-network is the Internet network.

4. The software system of claim 1 wherein the software system is distributed whole or in part to an enterprise responsible for operating the system and retained whole or in part by an enterprise providing the distributable portion.

5. The software system of claim 1 wherein the performance of the software system is monitored whole or in part by the provider of the system for the purpose of maintaining, updating, and enhancing the system.

6. The software system of claim 5 wherein the intelligence is created by system monitoring from the provider location and wherein summary reports containing the intelligence are created and provided to the enterprise hosting the software system.

7. The software system of claim 1 wherein the multiple data sources include web sites, online or internal databases, display interfaces, and live data feeds.

8. The software system of claim 1 wherein the network is internal to the enterprise operating the software system.

9. The software system of claim 8 wherein the network is a local area network and the data gathered includes data from at least one internal database connected to the local area network.

10. The software system of claim 9 wherein the included data is data obtained from display interfaces connected to the local area network.

11. A data engine for gathering and processing data from multiple and disparate data sources comprising;
a data gathering layer for gathering the data;
a data normalization layer for normalizing data types from multiple data sources;
a data cleansing layer for correcting data inconsistencies;
a data enrichment layer for rendering data analyzable; and
an application interface layer for providing multiple interfaces to like multiple user applications;
characterized in that the data engine serves as a central processing hub in an enterprise for generating useful services that are client specific and enterprise specific.

12. The data engine of claim 11 wherein the data sources are network sources and the network is the Internet network.

13. The data engine of claim 11 wherein the data sources are network sources and the network is a local area network.

14. The data engine of claim 11 wherein the data engine is distributed in part to an enterprise responsible for operating the system and retained in part by an enterprise providing the distributable portion.

15. The data engine of claim 11 wherein the performance of the data engine is monitored by the provider of the system for the purpose of maintaining, updating, and enhancing the services provided by the engine.

16. The data engine of claim 15 wherein intelligence is created by system monitoring from the provider location and wherein summary reports containing the intelligence are created and provided to the enterprise hosting the data engine.

17. The data engine of claim 11 wherein the data sources include web sites, online databases, display interfaces, and live data feeds.

18. The data engine of claim 11 wherein the data sources include an internal database and display systems connected thereto by a local area network internal to a hosting enterprise.

19. A data management system having components distributed across a service provider site and a partner site, comprising:
a system server at the provider site connected by a data link to components at the partner site, for remote monitoring of components at the partner site;
a management server at the partner site for overall management of system activities at the partner site;
a data gathering engine controlled by the management server for collecting and integrating data from a plurality of data sources accessible by the data gathering engine;
a local database for storage of collected and integrated data; and
a client interface enabling clients of the partner site to access services at the partner site.

20. The system of claim 19 wherein the data sources include one or more of Internet sites, remote legacy sites, and data sources local to the partner site.

21. The system of claim 20 further comprising a facility for data cleansing and normalization in the data gathering and integration.

22. The system of claim 19 wherein the client interface comprises an Internet-connected WEB server, through which clients may access, through personalized WEB pages, services at the partner site.

23. The system of claim 19 wherein the system server provides both monitoring and troubleshooting of operations at the partner site.

24. The system of claim 19 wherein the system server comprises one or more workstations having a graphical user interface for a knowledge worker to interact with the operations at the partner site.

25. The system of claim 19 further comprising an update server at the provider site, the update server enabled to provide periodic system updates to components at the partner site.

26. The system of claim 19 wherein any one or more of components other than the system server is implemented at the provider site, with the client interface remaining at the partner site.

27. A method for enabling, by a provider, client services requiring data collection for a partner enterprise at a partner site, comprising the steps of:
(a) establishing at the partner site a management server for overall management of system activities, a data gathering engine controlled by the management server for collecting and integrating data from a plurality of data sources accessible by the data gathering engine, a local database for storage of collected and integrated data, and a client interface enabling clients of the partner site to access services at the partner site; and
(b) establishing at the provider site a system server connected by a data link to components at the partner site, for remote monitoring of components at the partner site.

28. The method of claim 27 wherein the data sources include one or more of Internet sites, remote legacy sites, and data sources local to the partner site.

29. The method of claim 28 further comprising a facility for data cleansing and normalization in the data gathering and integration.

30. The method of claim 27 wherein the client interface comprises an Internet-connected WEB server, through which clients may access, through personalized WEB pages, services at the partner site.

31. The method of claim 28 wherein the system server provides both monitoring and troubleshooting of operations at the partner site.

32. The method of claim 27 wherein the system server comprises one or more workstations having a graphical user interface for a knowledge worker to interact with the operations at the partner site.

33. The method of claim 27 further comprising an update server at the provider site, the update server enabled to provide periodic system updates to components at the partner site.

34. The method of claim 27 wherein any one or more of components other than the system server is implemented at the provider site, with the client interface remaining at the partner site.
